(19) United States
(12) Patent Application Publication
(10) Pub. No.: US 2006/0228258 A1
(43) Pub. Date: Oct. 12, 2006

(54) Blood collection and measurement apparatus

(75) Inventor: James Samsoondar, Cambridge (CA)

Correspondence Address: BERESKIN AND PARR, 40 KING STREET WEST, BOX 401, TORONTO, ON, M5H 3Y2, CA

(73) Assignee: Chromedx Inc., Cambridge (CA)

(21) Appl. No.: 11/103,619

(22) Filed: Apr. 12, 2005

(51) Int. Cl. G01N 21/00

(52) U.S. Cl. 422/82.05

(57) ABSTRACT

Some embodiments of the invention provide one apparatus that is suitable for both the collection and measurement of a blood sample. Once a blood sample is drawn into such an apparatus the blood sample can be analyzed, without having to transfer any portion of the blood sample into another vessel. Also, in some very specific embodiments, the apparatus is provided with an optical chamber that is specifically designed to reduce the average attenuation of electromagnetic radiation (EMR) due to scattering of EMR by the red blood cells in a blood sample, without having to hemolyze the red blood cells by using sound waves or by adding reagents to the blood sample. Moreover, as a result of the time saved by using a single apparatus for blood sample collection and measurement, the addition of an anticoagulant is not required to prevent clotting. Moreover, in such embodiments the optical chamber is designed to spread blood into a thin film, thereby reducing the incidences of trapped air bubbles in the collected blood sample in the optical chamber. Instead air bubbles are easily pushed through the optical chamber and guided out of the apparatus through a vent. Optionally, at least one biosensor may be provided within a second flow path in the apparatus.

### FIELD OF THE INVENTION

The invention relates to blood analysis, and, in particular to an apparatus used in both the collection and measurement of a blood sample.

### BACKGROUND OF THE INVENTION

There are many medical diagnostic tests that require a blood sample. In general, conventional methods of collecting and analyzing blood leads to inevitable delays, unnecessary handling of the blood and the introduction of contaminants, which are all known sources of analysis error. More specifically, as per convention, a blood sample is typically withdrawn using one instrument/vessel and then transferred into another vessel for analysis. For example, a syringe is used to obtain a relatively large blood sample that is later put into tests tubes. Syringe extraction of blood is beneficial in circumstances where several milliliters of blood are needed. Alternatively, much smaller blood samples (e.g. in the range of micro-liters) can be obtained using a pinprick and then a capillary tube that is inserted into a drop of blood that oozes onto the skin surface. Blood from the drop flows into the capillary tube as a result of capillary action. Irrespective of the amount, collected blood is transferred into another vessel to be analyzed. The eventual transfer of blood between vessels delays the actual analysis of the blood sample and also exposes the blood sample to contaminants. Moreover, the red blood cells are alive and continue to consume oxygen during any delay period, which in turn changes chemical composition of the blood sample in between the time the blood sample is obtained and the time the blood sample is finally analyzed. In many cases reagents are also often added to a blood sample to prevent clotting or to hemolyze red blood cells before the analysis is eventually carried out. Such reagents dilute a blood sample and cause significant errors if the volume of the blood sample is small.

One example of a blood analysis technique that is affected by the aforementioned sources of error is co-oximetry. Co-oximetry is a spectroscopic technique that can be used to measure the different Hemoglobin (Hb) species present in a blood sample. The results of co-oximetry can be further evaluated to provide Hb Oxygen Saturation (sO₂) measurements. If the blood sample is exposed to air the Hb sO₂ measurements are falsely elevated, as oxygen from the air is absorbed into the blood sample. Co-oximetry also typically requires the hemolyzing of red blood cells to make the blood sample suitable for spectroscopic measurement. The volume of the blood sample has to be large enough to compensate for errors caused by an added hemolyzing reagent and an anticoagulant.

Preferably, Hb sO₂ is measured from arterial blood, since arterial blood provides an indication of how well venous blood is oxygenated in the lungs. Arterial blood must be collected by a doctor or a specially-trained technician, using a syringe, because of a number of inherent difficulties associated with the complicated collection procedure. Notably, the collection of arterial blood is far more painful, difficult and dangerous for a patient, especially an infant, than the collection of venous blood.

Extracting several milliliters of arterial blood from an infant can threaten the life of the infant. As an alternative, capillary blood is used. The capillary blood is extracted by a finger or heel prick, after gently heating the skin. The capillary blood sample is collected with a capillary tube that is internally coated with an anticoagulant. Given the small volume, significant analysis errors can stem from the addition of the anticoagulant. Moreover, the presence of small air bubbles trapped inside the capillary tube also lead to analysis errors, because the partial pressure of oxygen in the sample rises. Evidence of this is found in the Tietz Textbook of Clinical Chemistry, 3rd ed. (ISBN: 0721656102); which describes a representative example of how a 100 micro-liters air-bubble causes a 4 mm of mercury increase in the partial pressure of oxygen in a 2 ml blood sample. It is commonly understood that this effect increases as the ratio of blood sample volume to air volume decreases.

### SUMMARY OF THE INVENTION

According to an aspect of an embodiment of the invention there is provided a blood sample collection and measurement apparatus comprising: (a) a housing having a side dimension and a depth dimension orthogonal to the side dimension, (b) an inlet transition cavity within the housing for receiving blood to be analyzed; (c) an optical chamber, within the housing, for receiving the blood from the inlet transition cavity, the optical chamber having at least one optical window for viewing the blood and an optical chamber depth extending from the at least one optical window parallel to the depth dimension; (d) an overflow chamber, within the housing, for receiving blood from the optical chamber; and (e) an outlet vent, in the housing and fluidly connected to the overflow chamber, to provide an outflow path for air.

Other aspects and features of the present invention will become apparent, to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1A is a schematic drawing showing a top view of an apparatus suitable for both the collection and measurement of a blood sample according to a first embodiment of the invention;

FIG. 1B is a cross-sectional view through the apparatus shown in FIG. 1A along line A-A;

FIG. 1C is an alternative cross-sectional view through the apparatus shown in FIG. 1A along line A-A;

FIG. 2 is a schematic drawing showing a top view of an apparatus suitable for both the collection and measurement of a blood sample according to a second embodiment of the invention;

FIG. 3 is a schematic drawing showing a top view of an apparatus suitable for both the collection and measurement of a blood sample according to a third embodiment of the invention;

FIG. 4 is a schematic drawing showing a top view of an apparatus suitable for both the collection and measurement of a blood sample according to a fourth embodiment of the invention;

FIG. 5 is a schematic drawing showing a top view of an apparatus suitable for both the collection and measurement of a blood sample according to a fifth embodiment of the invention;

FIG. 6 is a schematic drawing showing a top view of an apparatus suitable for both the collection and measurement of a blood sample according to a sixth embodiment of the invention;

FIG. 7 is a schematic drawing showing a top view of an apparatus suitable for both the collection and measurement of a blood sample according to a seventh embodiment of the invention;

FIG. 8A is a schematic drawing showing a top view of an apparatus, that includes biosensors, suitable for both the collection and measurement of a blood sample according to a eighth embodiment of the invention;

FIG. 8B is a cross-sectional view through the apparatus shown in FIG. 8A along line B-B;

FIG. 8C is a cross-sectional view through the apparatus shown in FIG. 8A along line C-C;

FIG. 8D is a cross-sectional view through the apparatus shown in FIG. 1A along line D-D;

FIG. 9 is a schematic drawing showing a top view of an apparatus, that includes biosensors, suitable for both the collection and measurement of a blood sample according to a ninth embodiment of the invention; and

FIG. 10 is a schematic drawing showing a top view of an apparatus, that includes biosensors and a built-in calibration system, suitable for both the collection and measurement of a blood sample according to a tenth embodiment of the invention.

### DETAILED DESCRIPTION OF PREFERRED ASPECTS OF THE INVENTION

Some embodiments of the invention provide one apparatus that is suitable for both the collection and measurement of a blood sample. Once a blood sample is drawn into such an apparatus the blood sample can be analyzed, without having to transfer any portion of the blood sample into another vessel. Also, in some very specific embodiments, the apparatus is provided with an optical chamber that is specifically designed to reduce the average attenuation of electromagnetic radiation (EMR) due to scattering of EMR by the red blood cells in a blood sample, without having to hemolyze the red blood cells by using sound waves or by adding reagents to the blood sample. Moreover, as a result of the time saved by using a single apparatus for blood sample collection and measurement, the addition of an anticoagulant is not required to prevent clotting. Moreover, in such embodiments the optical chamber is designed to spread blood into a thin film, thereby reducing the incidences of trapped air bubbles in the collected blood sample in the optical chamber. Instead air bubbles are pushed through the optical chamber and guided out of the apparatus through a vent.

Moreover, in some embodiments blood within the optical chamber is further isolated from contamination by room air by providing an inlet transition cavity and an overflow chamber at a respective entrance and exit of the optical chamber. In use, blood in the inlet transition cavity and the overflow chamber serve as respective barriers between blood in the optical chamber and room air, thereby isolating the blood in the optical chamber from oxygen contamination. In the rare incident of a trapped air bubble, those skilled in the art will appreciate that various known calibration algorithms for many specific analytes measured in the blood sample can be used to compensate for measurement inaccuracies caused by a trapped air bubbles, except for those analytes such as the partial pressure of oxygen and oxy-hemoglobin, which become falsely elevated as a result of oxygen introduced into the blood sample from the air bubble.

In some embodiments the apparatus includes at least one visible fill line or indicator serving as a marker providing a user with a visual Boolean indicator relating to the sufficiency of the blood sample in the optical chamber. Briefly, in some embodiments, the visible fill line is located in a position in and/or beyond the overflow chamber that is indicative of whether or not a volume of blood drawn into the apparatus is present in sufficient amount to: i) ensure that the blood in the optical chamber is substantially free from contaminants that may have been introduced during the collection of the blood sample; and/or, ii) ensure that there is an effective amount of blood surrounding the optical chamber to isolate the blood in the optical chamber from room air.

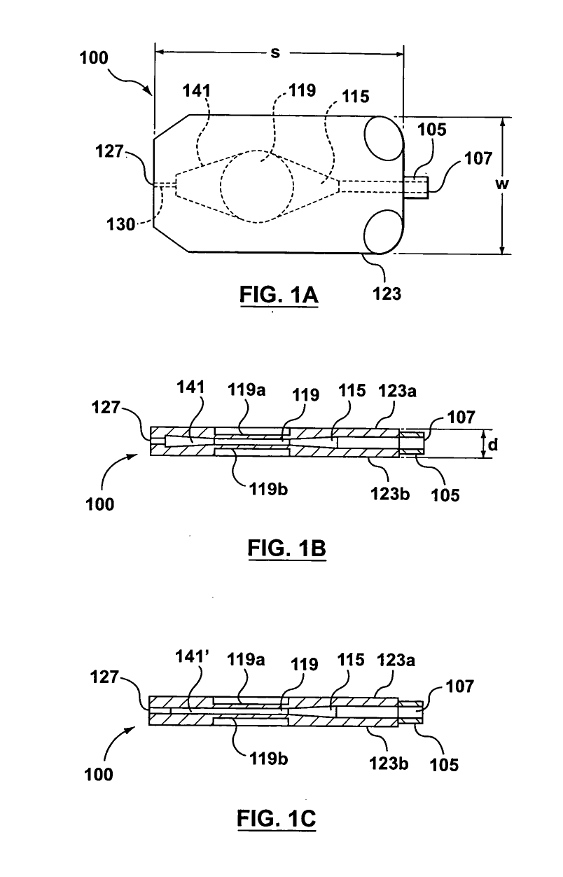

In accordance with an embodiment of the invention, a very specific example of an apparatus suitable for the collection and measurement of a blood sample is shown in FIGS. 1A and 1B. Specifically, FIG. 1A is a schematic drawing illustrating the top view of an apparatus 100, and FIG. 1B is a cross-sectional view through the apparatus 100 along line A-A in FIG. 1A. The apparatus 100 includes a housing 123 defining an internal volume between an inlet 107 and an outlet vent 127. As shown, the housing 123 has a side dimension s, a width dimension w, and a depth dimension d. The internal volume includes three distinct portions including an inlet transition cavity 115, an optical chamber 119 and an over flow chamber 141 that are fluidly connected in series. The inlet transition cavity 115 is fluidly connected between the optical chamber 119 and the inlet 107. In this particular embodiment a short protruding length of capillary tube 105 defines the inlet 107 for the apparatus 100, and extends into fluid connection with the inlet transition cavity 115 from the inlet 107. The overflow chamber 141 is fluidly connected between the optical chamber 119 and the outlet vent 127. In this particular embodiment, a short capillary tube 130 connects the overflow chamber 141 to the outlet vent 127. With specific reference to FIG. 1B, respective optically transparent (or translucent) top and bottom wall-portions 119a and 119b of the housing 123 define the optical chamber 119. Further, in this preferred embodiment, the top and bottom wall-portions 119a, 119b are recessed with respect to the corresponding top and bottom surfaces 123a, 123b of the housing 123 in order to protect the exterior faces of the top and bottom wall-portions 119a, 119b from scratches, although those skilled in the art will appreciate that this is not essential. In some embodiments, the interior walls of the apparatus are also treated with a hydrophilic coating to promote even spreading of the blood within the optical chamber 119.

Generally, even without a hydrophilic coating, the interior of the optical chamber 119 is designed to evenly spread blood into a thin film free of air bubbles. Briefly, in use, a thin film of blood completely filling the optical chamber 119 is suitable for spectroscopic analysis through the top and bottom wall-portions 119a, 119b.

With further specific reference to FIG. 1B, the interior of optical chamber 119 is much thinner in depth than the diameter of the interior of the capillary tube 105 and the broad end of the inlet transition cavity 115. In some embodiments, the depth of the optical chamber 119, being the internal distance between the respective interior faces of the top and bottom wall-portions 119a and 119b, ranges from approximately 0.02 mm to 0.2 mm, whereas the diameter of the capillary tube is about 0.5 mm to 2.0 mm. Light scattering caused by red blood cells is more prevalent when the depth of the optical chamber 119 is more than 0.1 mm, and so a depth of less than 0.1 mm is preferred. If the depth is less than 0.02 mm the natural viscosity of blood may reduce how effectively blood can be spread evenly through the optical chamber 119. Moreover, with further reference to FIG. 1A, the widthwise span of the optical chamber 119 (relative to the width of the apparatus 100) is wider than the diameter of the interior of the capillary tube 105 and is substantially equal to or larger than the broad end of the inlet transition cavity 115. Specifically, the width-wise span (in this embodiment the diameter in the top view, shown in FIG. 1A) of the optical chamber 119 ranges, without limitation, between approximately 2 to 10 mm. Taken together the dimensions of the optical chamber 119 preferably result in an approximate volume of less than 2 micro-liters, and more preferably about 1 micro-liter.

The inlet transition cavity 115 is provided to serve as a transition between the inlet 107 and the optical chamber 119 and a barrier between room air and blood in the optical chamber 119. As noted above, the capillary tube 105 defines the inlet 107. The inlet transition cavity 115 is tapered towards the optical chamber 119 so as to have a diminishing depth and an increasing width relative to the diameter of the capillary tube 105 in the direction of the optical chamber 119 from the capillary tube 105. Moreover in use, blood remaining in the inlet transition cavity 115 serves as a barrier between room air and the blood in the optical chamber 119 through which air cannot easily diffuse toward the blood in the optical chamber 119. In terms of total volume, the inlet transition cavity 115 and the capillary tube 105 preferably have a combined volume in the approximate range of 5-15 micro-liters.

Referring to FIG. 1B, the overflow chamber 141 is similarly provided to serve as a transition between the outlet vent 127 and the optical chamber 119 and a barrier between room air and blood in the optical chamber 119 during operation. In this particular embodiment, the overflow chamber 141 has a complementary design to that of the inlet transition cavity 115. That is, the overflow chamber 141 is flared away from the optical chamber 119 so as to have an increasing depth and a decreasing width in the direction away from the optical chamber 119. The depth of the overflow chamber 141 increases toward the vent to preferably exceed 2 mm to provide a capillary break. In this particular embodiment, the volume of the overflow chamber 141 is larger than that of the optical chamber 119, and during operation filling the overflow chamber 141 ensures that blood in the optical chamber is substantially free from contamination and effectively isolated from room air that may enter via the outlet vent 127. In terms of total volume, the overflow chamber 141 has a volume that is preferably greater than the approximate volume of the optical chamber 119. Preferably, the sum of the volumes of the overflow chamber 141, optical chamber 119, and inlet transition cavity 115, is less than 30 micro-liters, and more preferably is less than 15 micro-liters.

An alternative cross-sectional profile for the overflow chamber 141 is shown in FIG. 1C. For clarity, the same reference numerals, together with an apostrophe, are used to designate elements analogous to those described above in connection with FIG. 1B. However, for clarity, the description of FIG. 1B is not repeated with respect to FIG. 1C.

Instead, of increasing in depth, as shown in FIG. 1B, the overflow chamber 141 shown in FIG. 1C has a uniform depth that is the same as that of the optical chamber 119. This alternative is useful in embodiments where the optical chamber 119 has a relatively small volume, and it is not necessary to have a relatively large overflow chamber 141.

Before the apparatus 100 is employed during a blood test, room air is present within the internal volume (i.e. within the inlet transition cavity 115, the optical chamber 119, and the overflow chamber 141, etc.). The room air contains oxygen and other gases that could contaminate a blood sample drawn into the apparatus 100. However, when the apparatus is used properly blood within the optical chamber 119 is substantially free from such contaminants, and does not require the addition of a hemolyzing agent or an anticoagulant to ensure that the blood sample in the optical chamber is suitable for spectroscopic analysis. Specifically, in operation, the end of the capillary tube 105 is inserted into a blood drop. Blood flows through the inlet 107 as a result of capillary action. The leading surface of the inflowing blood is exposed to the room air within the apparatus 100, which is simultaneously being forced out of the vent 127 by the inflow of blood. The vent 127 provides a flow path for the room air that moves away from the inflow of blood. Without the vent 127, room air would flow back through the inflowing blood, thereby contaminating the blood sample and possibly leaving air bubbles within the apparatus 100. Eventually, enough blood enters the apparatus 100 to fill the overflow chamber 141, thereby forcing room air out of the apparatus 100 through the vent 127. Any blood that was exposed to the room air during the filling process is in the overflow chamber 141 and not within the optical chamber 119 and internal pressure prevents back flow of the blood. Thus, any contaminated blood, from the leading surface of the blood during the filling stage, is expected to remain in the overflow chamber 141. As noted previously, the blood in the inlet transition cavity 115 and the blood in the overflow chamber 141 effectively isolate the blood in the optical chamber 119 from further contamination from the room air. Once the blood is collected in the apparatus, it is ready for measurement by inserting the apparatus into a slot in a diagnostic instrument (not shown). The vent 127 in FIG. 1A is inserted first, but in further embodiments described below, the location of the vent is such that the vent would remain outside of the diagnostic instrument, after the apparatus is fully inserted. The alternative locations of the vents provide safeguards that would minimize the risk of contaminating the diagnostic instrument with blood.

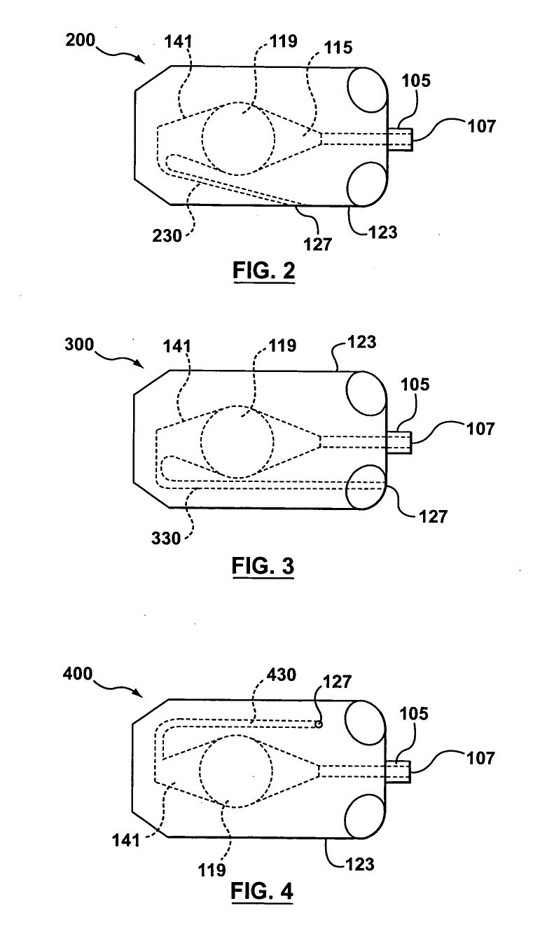

Referring to FIG. 2, shown is a top view of an apparatus 200 suitable for both the collection and measurement of a blood sample according to a second embodiment of the invention. The apparatus 200 illustrated in FIG. 2 is similar to the apparatus 100 illustrated in FIG. 1, and accordingly, elements common to both share common reference numerals. The primary difference, illustrated in FIG. 2, is that the vent 127 is now located on a lateral side of the housing 123 as opposed to being directly opposite the inlet 107 along a shared axis. In order to accommodate the new location of the vent 127, a curved outlet capillary tube 230 fluidly connects the rear of the overflow chamber 141 to the vent 127 on the lateral side of the housing 123.

Referring to FIG. 3, shown is a top view of an apparatus 300 suitable for both the collection and measurement of a blood sample according to a third embodiment of the invention. The apparatus 300 illustrated in FIG. 3 is similar to the apparatus 100 illustrated in FIG. 1, and accordingly, elements common to both share common reference numerals. The primary difference, illustrated in FIG. 3, is that the vent 127 is now located on the same side of the housing 123 as the inlet 107. In order to accommodate the new location of the vent 127, an L-shaped capillary tube 330 fluidly connects the rear of the overflow chamber 141 to the vent 127 on the front side of the housing 123.

Referring to FIG. 4, shown is a top view of an apparatus 400 suitable for both the collection and measurement of a blood sample according to a fourth embodiment of the invention. The apparatus 400 illustrated in FIG. 4 is similar to the apparatus 100 illustrated in FIG. 1, and accordingly, elements common to both share common reference numerals. The primary difference, illustrated in FIG. 4, is that the vent 127 is now located on the top surface 123a of the housing 123 as opposed to directly opposite the inlet 107 along a shared axis. In order to accommodate the new location of the vent 127, an L-shaped capillary tube 430 fluidly connects the rear of the overflow chamber 141 to the vent 127 on the top surface 123a of the housing 123. Moreover, in comparison with the apparatus 300 shown in FIG. 3, the L-shaped capillary tube 430 is similar to the L-shaped capillary tube 330 with the exception that the L-shaped capillary tube 430 does not extend all the way to the front side of the housing 123, but instead is connected to the vent 127 on the top surface 123a of the housing 123.

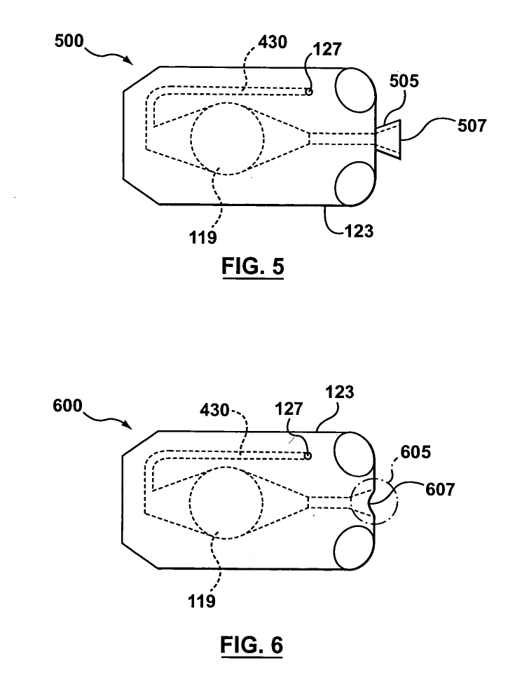

Referring to FIG. 5, shown is a top view of an apparatus 500 suitable for both the collection and measurement of a blood sample according to a fifth embodiment of the invention. The apparatus 500 illustrated in FIG. 5 is similar to the apparatus 400 illustrated in FIG. 4, and accordingly, elements common to both share common reference numerals. The primary difference, illustrated in FIG. 5, is that end of the inlet capillary tube 105 has been replaced with a flared capillary tube end 505, thereby defining an inlet 507 in place of the original inlet 107 (shown in FIGS. 1-4). The inlet 507 is large enough to accommodate the male end of a syringe (not shown), yet also small enough to encourage blood inflow via capillary action, if the end 505 is inserted into a drop of blood. The apparatus 500 is well suited for scenarios where blood from a syringe is available, as blood can be passed directly from the syringe to the apparatus 500 without exposure to room air. Because of the relatively large inlet 507, the apparatus 500 is also well suited for squeezing blood directly into the apparatus 500 by placing the flared end 505 over the pin prick. In such a case, a drop of blood at the pin-prick site is not required, and therefore an even smaller blood volume would be required.

Referring to FIG. 6, shown is a top view of an apparatus 600 suitable for both the collection and measurement of a blood sample according to a sixth embodiment of the invention. The apparatus 600 illustrated in FIG. 6 is similar to the apparatus 400 illustrated in FIG. 4, and accordingly, elements common to both share common reference numerals. The primary difference, illustrated in FIG. 6, is that end of the inlet capillary tube 105 has been recessed into the housing 123, shown as 605, thereby defining an inlet 607 in place of the original inlet 107 (shown in FIGS. 1-4). The inlet 607 is large enough to accommodate the male end of a syringe (not shown), yet also small enough to encourage blood inflow via capillary action, if the inlet 607 is placed over a drop of blood. The apparatus 600 is well suited for scenarios where blood from a syringe is available, since blood can be passed directly from the syringe to the apparatus 600 without exposure to room air. Because of the relatively large inlet 607, the apparatus 600 is also well suited for squeezing blood directly into the apparatus 600 by placing the flared end 605 over the pin prick. In such a case, a drop of blood at the pin-prick site is not required, and therefore an even smaller blood volume would be required.

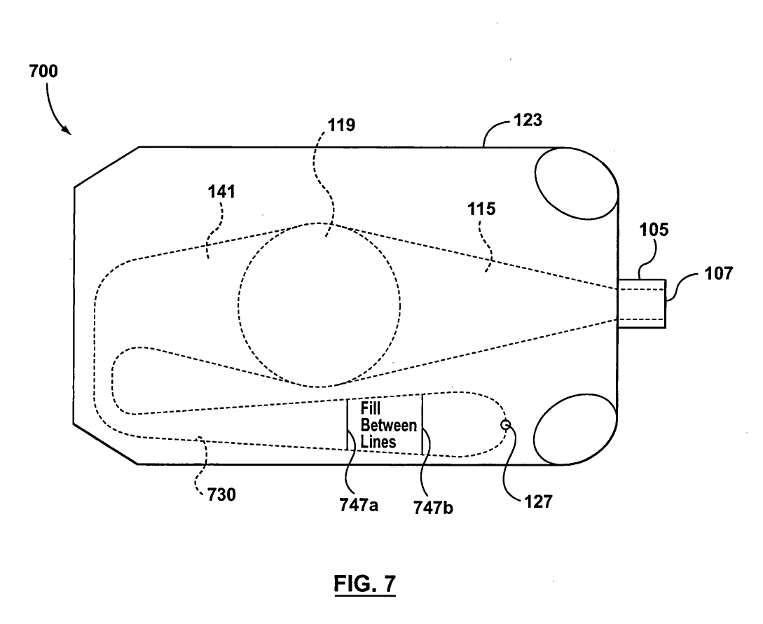

Referring to FIG. 7, shown is a top view of an apparatus 700 suitable for both the collection and measurement of a blood sample according to a seventh embodiment of the invention. The apparatus 700 illustrated in FIG. 7 is similar to the apparatus 400 illustrated in FIG. 4, and accordingly, elements common to both share common reference numerals. The primary difference, illustrated in FIG. 7, is that the L-shaped capillary tube 430 has been replaced with a modified L-shaped capillary tube 730. The modified L-shaped capillary tube 730 increases in diameter towards the vent 127 and includes respective first and second visible fill lines 747a and 747b. In this particular embodiment, proper use requires that enough blood flows into the apparatus 700 to at least pass the first fill line 747a. Overfilling past the second fill line 747b will not compromise the blood sample within the optical chamber, but excess filling may cause blood to flow through the vent 127 onto the top surface 123a of the housing, thereby contaminating the top surface 123a with potentially biologically hazardous material (e.g. blood infected with a particular blood-borne infectious pathogen). Additionally and/or alternatively, in some embodiments, because a significant amount of blood is within the outlet capillary tube 730, the volume of the overflow chamber 141 can be reduced. Accordingly, in some embodiments the combined volume of the overflow chamber 141 and the capillary tube 730, before the first visible fill line 747a, can be designed to be equal to or greater than the volume of the optical chamber 119. Moreover, as is illustrated in FIG. 7, because the cross-sectional area of the outlet capillary tube 730 gradually increases from the first to the second fill lines 747a and 747b, the section defined between the first and second fill lines 747a and 747b could act as a capillary break, thereby reducing the rate of blood flow once blood reaches said section.

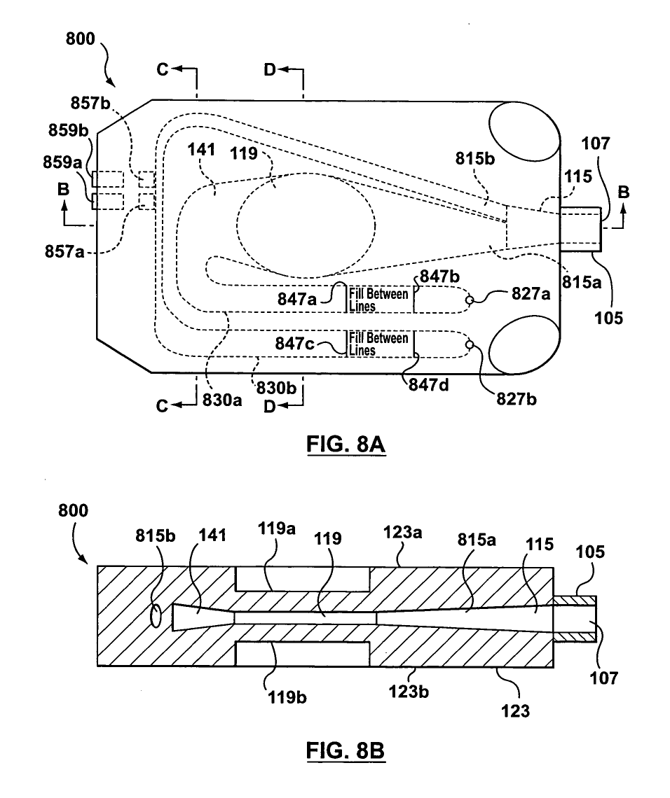

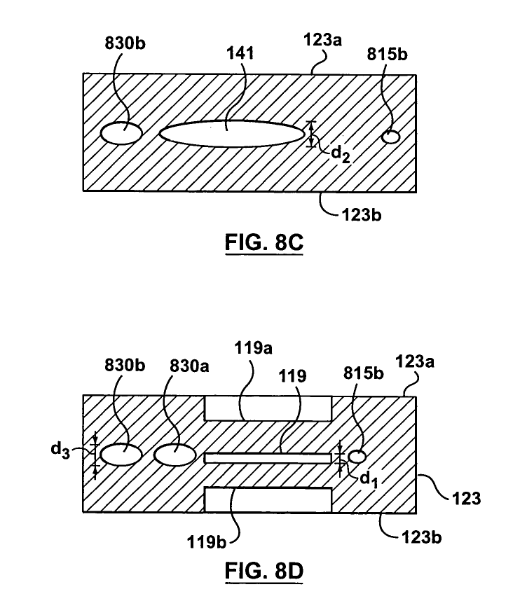

Referring to FIGS. 8A-8D, shown are schematic drawings of an apparatus 800 suitable for both the collection and measurement of a blood sample according to a eighth embodiment of the invention. Specifically, FIG. 8A is a schematic drawing of a top view of the apparatus 800. FIGS. 8B, 8C and 8D are respective cross-sectional views along corresponding lines B-B, C-C and D-D provided in FIG. 8A. The apparatus 800 illustrated in FIGS. 8A-8D is similar to the apparatus 400 illustrated in FIG. 4, and accordingly, elements common to both share common reference numerals.

Referring collectively to FIGS. 8A-8D, the apparatus 800 differs from the apparatus 400, shown in FIG. 4, in that it includes two independent paths for the analysis of blood. The two paths are split from the inlet transition cavity 115. The first path is suitable for spectroscopic analysis of blood, whereas the second path is suitable for blood analysis employing the use of biosensors.

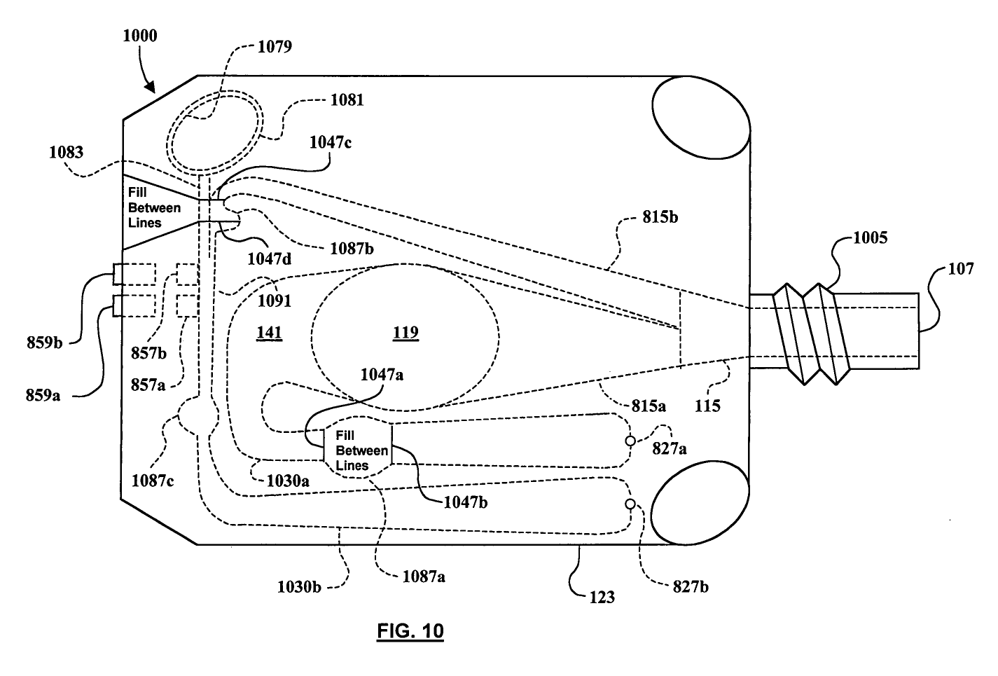

More specifically, the first path includes a first inlet transition path 815a leading to the optical chamber 119, which is connected to the overflow chamber 141 as described above. The overflow chamber 141 is then fluidly connected to a first L-shaped outlet capillary tube 830a. The first outlet capillary tube 830a terminates at a first vent 827a and includes first and second visible fill lines 847a and 847b. Those skilled in the art will appreciate that the capillary tube 830a, the vent 827a and the visible fill lines 847a, 847b serve the same purpose as the capillary tube 730, the vent 127 and the visible fill lines 747a, 747b described above with reference to FIG. 7. Accordingly, for the sake of brevity the functional description of these elements will not be repeated. Similarly, the second path includes a second inlet transition path 815b that transitions into a second outlet capillary tube 830b. Between the second inlet transition path 815b and the second outlet capillary tube 830b, is a biosensor chamber 1091 (shown in FIG. 10) where the blood makes contact with the biosensors 857a and 857b. The second outlet capillary tube 830b terminates at a second vent 827b and includes third and fourth visible fill lines 847c and 847d. Again, those skilled in the art will appreciate that the capillary tube 830b, the vent 827b and the visible fill lines 847c, 847d serve the same purpose as the capillary tube 730, the vent 127 and the visible fill lines 747a, 747b described above with reference to FIG. 7. Accordingly, for the sake of brevity the functional description of these elements will not be repeated.

Additionally, along the second flow path, defined by the second inlet transition path 815b and the second outlet capillary tube 830b, biosensors 857a, 857b are provided. The biosensors 857a, 857b are coupled to respective electrical contacts 859a, 859b that provide connectivity between the apparatus 800 and a diagnostic instrument suitable for processing the outputs of the biosensors 857a, 857b. Such an instrument (not shown) may include a programmed general-purpose computer and/or microprocessor in combination with a suitable combination of hardware, software and firmware. Those skilled in the art will appreciate that the biosensors can be pre-calibrated and the calibration algorithms installed in the diagnostic instrument. Moreover, those skilled in the art will also appreciate that one or more biosensors may be included in an apparatus according to an embodiment of the invention, and that only two have been illustrated in FIG. 8A as a non-limiting example. It will also be appreciated by those skilled in the art that the vents 827a and 827b could be merged into a single vent.

With specific reference to FIGS. 8C and 8D, the relative depth dimensions of the optical chamber 119, the overflow chamber 141 and first (and second) outlet capillary tube 830a (830b) are shown as d₁, d₂ and d₃, respectively. As described above, with reference to FIGS. 1A and 1B, the depth d₁ of the optical chamber 119 ranges from approximately 0.02 mm to 0.2 mm, whereas the diameter d₃ of the capillary tubes ranges from approximately 0.5 mm to 2.0 mm. Moreover, the depth d₂ of the overflow chamber 141 ranges from approximately 0.02 mm to 2.0 mm depending upon the final dimensions of the optical chamber 119 and the capillary tube 830a, since the overflow chamber 141 serves as a transition region between the optical chamber 119 and the capillary tube 830a. It should be understood that the cross-sectional areas shown are non-limiting examples, and those skilled in the art will appreciate that other cross-sectional areas could be used. Those skilled in the art will also appreciate that the internal walls of the optical chamber 119 do not have to be exactly parallel because the calibration algorithms for blood measurements can be developed to accommodate variability in depth d₁ of the optical chamber 119.

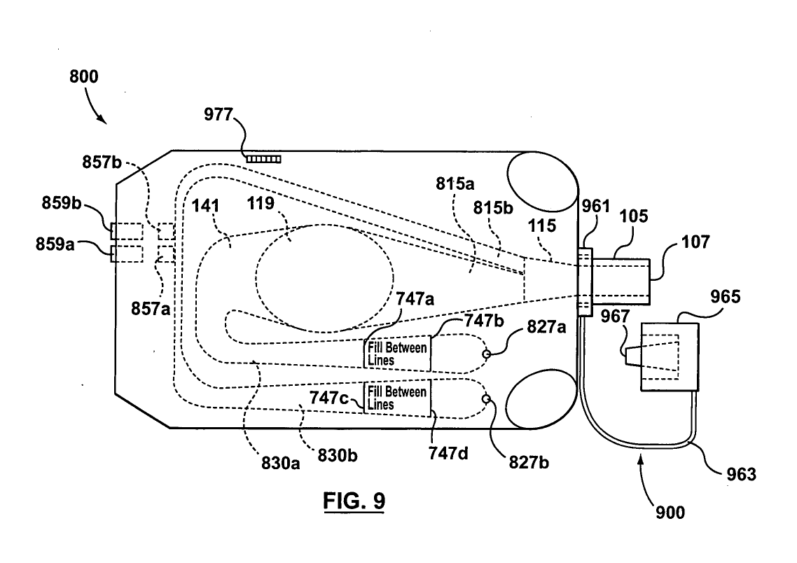

Referring to FIG. 9, and with further reference to FIG. 8A, the apparatus 800, in some embodiments, may be provided with a cap 965 and/or a barcode pattern 977.

The cap 965 is provided to close the inlet 107 before and after the apparatus is used. The cap 965 is optionally provided with a plunger 967, a tether 963 and a ring connector 961. The ring connector 961 is sized to fit securely around the protruding end portion of the capillary tube 105. The cap 965 is connected to the ring connector 961 by the tether 963, thereby connecting the cap 965 to the apparatus 800 even when the cap 965 is not placed on the protruding end portion of the capillary tube 105. One function of the cap 965 is to prevent contamination of the user and the diagnostic instrument with blood. The plunger 967 in the cap 965 is useful for exerting positive pressure on the blood sample, which feature will be described in more detail below in connection with the tenth embodiment of FIG. 10.

In some embodiments, the barcode pattern 977 may be marked on the apparatus to provide a means of identifying a particular apparatus 800. Additionally and/or alternatively, the barcode pattern 977 may also, without limitation, carry information relating to at least one of calibration information for the biosensors 857a, 857b, the production batch number of the biosensors 857a, 857b and/or the entire apparatus 800. Those skilled in the art will appreciate that the biosensors 857a and 857b in one apparatus 800 from a production batch can be calibrated, and the calibration algorithm developed can be stored in the diagnostic instrument and linked to the barcode pattern 977, which could be marked on each apparatus 800 from the production batch. Moreover, those skilled in the art will also appreciate that by linking the calibration algorithm to a barcode pattern 977, there is no need to calibrate the biosensors 857a and 857b in each apparatus 800.

As an alternative to using pre-calibrated biosensors, the tenth embodiment of the invention is shown in FIG. 10. The description that follows relates to a non-limiting example, of a method that may be used to calibrate the biosensors 857a and 857b in FIG. 10, in each apparatus 1000. Referring to FIG. 10, shown is a top view of an apparatus 1000 suitable for both the collection and measurement of a blood sample according to the tenth embodiment of the invention. The apparatus 1000 illustrated in FIG. 10 is similar to the apparatus 800 illustrated in FIG. 8, and accordingly, elements common to both share common reference numerals. The apparatus 1000 includes additional features that aid in the calibration of the biosensors 857a, 857b and control the inflow of a blood sample and calibration fluid. More specifically, the apparatus includes a calibration pouch 1079 containing calibration fluid, fitted inside a pouch cavity 1081, a first capillary break 1087a in the first flow path, and a second capillary break 1087b and a third capillary break 1087c in the second flow path. Additionally, the protruding open end of the inlet capillary tube 1005 (105 in FIG. 8) includes threads for connection with a correspondingly threaded cap (not shown) as an alternative to the tethered cap 965, with a plunger like the plunger 967 shown in FIG. 9.

The first capillary break 1087a is located between the visible fill lines 1047a and 1047b, and is in the form of a bulge between the overflow chamber 141 and the first outlet capillary tube 1030a. The second capillary break 1087b is located between the visible fill lines 1047c and 1047d, and is also in the form of a bulge between the second inlet transition path 815b and the biosensor chamber 1091. The third capillary break 1087c is also in the form of a bulge and is located between the biosensor chamber 1091 and the second outlet capillary tube 1030b. The inflow of blood into the first and second flow paths of the apparatus 1000 slows considerably when blood reaches the respective capillary breaks 1087a, 1087b. When the apparatus 1000 is used correctly, blood crosses visible fill lines 1047a and 1047c, before the apparatus 1000 is inserted into the slot of the diagnostic instrument, for calibration of the biosensors 857a and 857b. When blood enters a capillary break in one flow path the flow will stop, while the flow continues in the second flow path until a capillary break is reached.

The calibration pouch 1079 is connected to the second flow path into the biosensor chamber 1091 via a calibration conduit 1083. The calibration reservoir or pouch 1079 contains a calibration fluid used to calibrate the biosensors 857a, 857b after an intake of a blood sample. The second capillary break 1087b will prevent blood from flowing into the biosensor chamber 1091. When pressure is applied to a flexible surface of the pouch cavity 1081, the calibration pouch 1079 ruptures and the calibration fluid flows through the conduit 1083 and makes contact with biosensors 857a, 857b that measure the fluid. The third capillary break 1087c prevents the calibration fluid from flowing into the second outlet capillary tube 1030b, and the capillary break 1087b prevents the calibration fluid from flowing into the second inlet transition path 815b. Since the calibration fluid is a known substance having known properties, the initial measurements of the calibration fluid, made by the biosensors 857a and 857b, are then employed by a calibration algorithm that enables more accurate interpretation of subsequent biosensor readings of a blood sample. It will be appreciated by those skilled in the art that the calibration pouch 1079 can include a weakened wall portion designed to rupture when pressure is applied to the pouch cavity 1081, and a vacuum can be created within the pouch cavity 1081 when the pressure is released. The vacuum could withdraw some of the calibration fluid into the pouch cavity 1081, and the remaining calibration fluid would be flushed from the biosensor chamber 1091 by applying pressure to the blood in the inlet transition path 815b with the plunger 967 (shown in FIG. 9) in the cap. It will also be appreciated by those skilled in the art, that the pressure from the plunger 967 (FIG. 9) could be derived from the plunger of a small syringe fitted to an inlet like 507 or 607 as depicted in FIGS. 5 and 6 respectively.

In the example of a method of calibrating the biosensors 857a and 857b described in connection with FIG. 10, the blood is drawn into the apparatus 1000 before the calibration fluid from the calibration pouch 1079 is allowed to flood the biosensors, in order to calibrate the biosensors 857a and 857b. Those skilled in the art will appreciate that calibration of the biosensors 857a and 857b can be performed before the blood is drawn into the apparatus 1000.

With respect to spectroscopic measurements, the examples shown describe an apparatus that operates in transmission mode. Those skilled in the art will appreciate that the spectroscopic apparatus can also operate in reflectance mode by placing a reflecting member on one side of the optical chamber 119, such that the EMR transmitted through the sample would be reflected off the reflecting member, and the reflected EMR would enter the sample for the second time. In a diagnostic instrument operating in the reflectance mode, both the EMR source and the photodetector would be on the same side of the optical chamber 119. Moreover, those skilled in the art will also appreciate that instead of using a reflecting member in the diagnostic instrument, one side of the wall-portions (119a or 119b) of the optical chamber 119 could be coated with a reflecting material.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention. Numerous modifications and variations of the present invention are possible in light of the above teachings. It is therefore to be understood that within the scope of the appended claims, the invention may be practiced otherwise than as specifically described herein.

1. A blood sample collection and measurement apparatus comprising:
a housing having a side dimension and a depth dimension orthogonal to the side dimension,
an inlet transition cavity within the housing for receiving blood to be analyzed;
an optical chamber, within the housing, for receiving the blood from the inlet transition cavity, the optical chamber having at least one optical window for viewing the blood and an optical chamber depth extending from the at least one optical window parallel to the depth dimension;
an overflow chamber, within the housing, for receiving blood from the optical chamber; and
an outlet vent, in the housing and fluidly connected to the overflow chamber, to provide an outflow path for air.

2. A blood sample collection and measurement apparatus according to claim 1, wherein the inlet transition cavity has an inlet transition cavity depth parallel to the depth dimension and an inlet transition cavity width parallel to the side dimension.

3. A blood sample collection and measurement apparatus according to claim 1, wherein the average optical chamber depth is in the approximate range of 0.02 mm to 0.2 mm.

4. The fluid collection device as defined in claim 1 wherein the average optical chamber depth is less than 0.1 mm.

5. A blood sample collection and measurement apparatus according to claim 1, wherein the inlet transition cavity comprises a tapered transition region bordering the optical chamber, wherein within the tapered transition region the inlet transition cavity width increases toward the optical region and the inlet transition cavity depth diminishes toward the optical chamber.

6. A blood sample collection and measurement apparatus according to claim 5, wherein the inlet transition cavity width substantially equals an optical chamber width at a juncture of the transition region and the optical chamber, and the inlet transition cavity depth substantially equals the optical chamber depth at the juncture of the transition region with the optical chamber

7. A blood sample collection and measurement apparatus according to claim 1, wherein the inlet transition cavity has a respective inlet transition cavity volume and the optical chamber has an optical chamber volume, the optical chamber volume being less than half the inlet transition cavity volume.

8. A blood sample collection and measurement apparatus according to claim 7, wherein the optical chamber volume is less than one-quarter the inlet transition cavity volume.

9. A blood sample collection and measurement apparatus according to claim 8, wherein a sum of the overflow chamber volume, the optical chamber volume and the inlet transition cavity volume is less than 30 micro-liters.

10. A blood sample collection and measurement apparatus according to claim 9, wherein the sum of the overflow chamber volume, the optical chamber volume and the inlet transition cavity volume is less than 15 micro-liters, and the optical chamber volume is less than 2 micro-liters.

11. A blood sample collection and measurement apparatus according to claim 1, wherein the overflow chamber has an overflow chamber volume at least equal to the optical chamber volume.

12. A blood sample collection and measurement apparatus according to claim 1, wherein the overflow chamber has a tapered region, and within the tapered region, an overflow chamber depth increases away from the optical chamber and toward the vent such that the overflow chamber depth exceeds 2 mm before the outlet vent.

13. A blood sample collection and measurement apparatus according to claim 1 further comprising a visible fill line for indicating a total amount of the fluid received into the apparatus, the optical chamber and the overflow chamber.

14. A blood sample collection and measurement apparatus according to claim 1 further comprising a reflective coating on a wall-portion of the optical chamber.

15. A blood sample collection and measurement apparatus according to claim 1, wherein the inlet transition cavity branches into two independent flow paths, the two independent flow paths comprising a first flow path including the optical chamber and terminating at the outlet vent, and a second flow path including a capillary tube terminating at another outlet vent and at least one biosensor arranged adjacent to the capillary tube.

16. A blood sample collection and measurement apparatus as defined in claim 15 further comprising a cap for covering an opening into the inlet transition cavity, the cap having a plunger for exerting pressure on blood within the apparatus.

17. A blood sample collection and measurement apparatus according to claim 15, wherein at least one of the first and second flow paths includes a capillary break for slowing the inflow of blood.

18. A blood sample collection and measurement apparatus according to claim 15, wherein the second flow path includes a capillary break for slowing the inflow of calibration fluid.

19. A blood sample collection and measurement apparatus according to claim 15 further comprising a plunger for exerting pressure on the blood within the apparatus.

20. A blood sample collection and measurement apparatus according to claim 15 further comprising a calibration reservoir containing a calibration fluid and having a release means for releasing the calibration fluid into the second flow path for measurement by the at least one biosensor, the calibration fluid having at least one known property for measurement by the at least one biosensor.

21. A blood sample collection and measurement apparatus as defined in claim 20 wherein the calibration reservoir is flexible such that pressure can be provided to the calibration fluid within the calibration reservoir, and the release means comprises a weakened wall portion of the calibration reservoir, the weakened wall pressure being breakable by fluid pressure in the calibration fluid to release the calibration fluid into the second flow path.
